(19) United States
(12) Patent Application Publication
(10) Pub. No.: US 2004/0010690 A1
(43) Pub. Date: Jan. 15, 2004

(54) Method and system for inputting secret information

(76) Inventors: Eon-Cheol Shin, Inchon (KR); Eun-Sang Lee, Inchon (KR); Seung-Pyo Eun, Inchon (KR); Baek-Un Kim, Seoul (KR); Hak-Jae Shin, Suwon (KR); Tae-Ho Kim, Seoul (KR); Chae-Ho Cho, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/194,408

(22) Filed: Jul. 10, 2002

(51) Int. Cl. H04L 9/00

(52) U.S. Cl. 713/176

(57) ABSTRACT

A host computer determines the location of character values in which information on the location in which each of two or more character values distinguishable from each other is arranged on the screen is determined, and sends information on the determined locations to a remote terminal. The remote terminal displays the two or more character values according to the received information, displays a screen pointer and moves the screen pointer in response to a first event. The terminal transmits the information to the host computer in response to a second event. The host computer interprets a character value indicated by the screen pointer at the time when the second event is generated, using location information of the two or more character values determined and information on the screen pointer.

### RELATED APPLICATIONS

This application is related to U.S. patent applications Ser. Nos. 10/067,633 and 10/067,627, filed on Feb. 4, 2002, and entitled “METHOD AND APPARATUS FOR INPUTTING SECRET INFORMATION,” and “METHOD AND APPARATUS FOR INPUTTING SECRET INFORMATION USING MULTIPLE SCREEN POINTERS,” respectively which are incorporated by reference herein.

This application claims the benefit of the earlier filing date, under 35 U.S.C. §365 (c) and §120, of International Application No. PCT/KR00/01290 filed Nov. 11, 2000, designating the United States and being published in English as WO 02/39656 A1 on May 16, 2002, and which is incorporated by reference.

### BACKGROUND OF THE INVENTION

1. Field of the Invention

The present invention relates to a method and system for inputting secret information, and more particularly, to a method and system in which a user inputs secret information to a host computer using a remote terminal connected to the host computer through a communication network.

2. Description of the Related Technology

In an environment where a host computer and a remote terminal are connected to each other through a communication network, a system in which a user wishing to send secret information to the host computer sends secret information to the host computer using the remote terminal, is widely used at present. In addition, in electronic commerce or financial transactions through the Internet, an operation for sending secret information, such as credit information, to a remote host computer connected to the Internet is one of the essentially accompanying operations. as credit information, to a remote host computer connected to the Internet is one of the essentially accompanying operations.

However, during a process in which secret information input at a remote terminal by a user is sent to a host computer through a communication network, if a third person who accesses the communication network intercepts the secret information being sent from the remote terminal to the host computer, the secret information which the user wishes to input to the host computer may be used for unscrupulous purposes. Particularly when the secret information which the user wishes to input to the host computer is information on the user's financial account or credit card, the problem of secret information leakage becomes more serious.

Research on different methods to solve the problem is currently underway. One method which is widely used is an encryption method, in which content input by the user is encrypted using an encryption key or algorithm shared by the user and a host computer and then sent to the host computer. Also, encryption algorithms for the encryption methods have been developed in various forms.

However, new methods of intercepting information are continuously appearing to make such encryption methods of no use. One such information-snatching method is to install a daemon program in advance or secretly in a remote computer accessed by a user, so that the daemon program leaks to the outside through the communication network all input data that the user inputs through an input device such as the keyboard of the remote computer. If the information-snatching method is used, it is possible to leak all data input to the remote computer by the user. Also, based on the leaked data, secret information the user wishes to send to the host computer can be deciphered. As for the information-snatching method in which a pre-installed daemon program leaks all data input by the user to the outside, none of the conventional encryption methods, which encrypt secret information during a process for sending secret information from the remote computer to the host computer before sending, have any effect.

### SUMMARY OF CERTAIN INVENTIVE ASPECTS

To solve the above problems, it is desirable to provide a secret information input method for preventing the basic problem of the conventional encryption methods: the leakage of secret information input into a remote terminal by a user before encryption.

It is another aspect to provide a secret information input method in which, in an environment where a host computer and a remote terminal are connected to each other through a communication network, secret information is input to the remote terminal and sent to the host computer so that secret information cannot be leaked during the process.

In another aspect, there is provided a secret information input method for inputting secret information, using a remote terminal having a detector for detecting an event and a display, to a host computer which is connected to the remote terminal through a communication network. The host computer determines the location of character values in which information on the location in which each of two or more character values that can be distinguished from each other is arranged on the screen of the display is determined. The method comprises sending information on the determined locations to the remote terminal. The remote terminal receives the location information and displays the two or more character values that can be distinguished from each other on the display according to the received information. The method comprises displaying a screen pointer on the screen of the display, moving the screen pointer on the screen of the display in response to a first event detected by the detector, and transmitting information on the screen pointer to the host computer in response to a second event detected by the detector. The host computer receives information on the screen pointer transmitted by the remote terminal and records the information.

The host computer further performs interpreting a character value indicated by the screen pointer at the time when the second event is generated, using location information the two or more character values determined in the determining the location of character values and information on the screen pointer transmitted by the remote terminal.

### BRIEF DESCRIPTION OF THE DRAWINGS

FIG. 1 is a block diagram of an information processing system to which an embodiment of a secret information input method according to the present invention is applied;

FIG. 2 is a schematic diagram of an input screen to which an embodiment of a secret information input method according to the present invention is applied;

FIG. 3 is a flowchart showing the performing process of an embodiment of a secret information input method according to the present invention;

FIGS. 4A through 4E are schematic diagrams of various implementations of an input screen to which an embodiment of a secret information input method according to the present invention is applied;

FIG. 5 is a schematic diagram for showing character values and location information of character values according to an embodiment of a secret information input method of the present invention;

FIG. 6 is a schematic diagram for showing character values, character value reference values, and location information of character values according to another embodiment of a secret information input method of the present invention; and

FIG. 7 is a schematic diagram for showing character values, character value reference values, and location information of character values according to still another embodiment of a secret information input method of the present invention.

### DESCRIPTION OF CERTAIN INVENTIVE EMBODIMENTS

Hereinafter, certain embodiments of the present invention will be described in detail with reference to the attached drawings.

Information Processing System

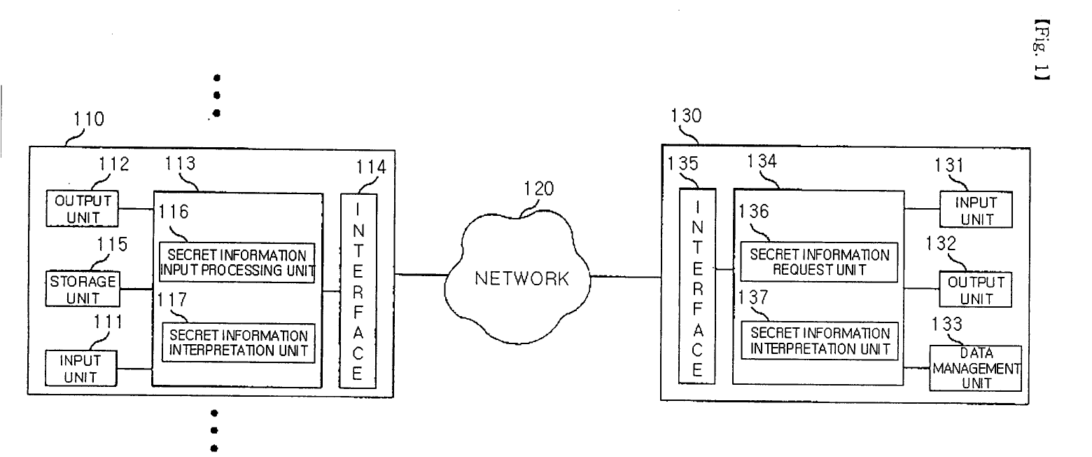

FIG. 1 is a block diagram of an information processing system to which an embodiment of a secret information input method according to the present invention is applied.

Referring to FIG. 1, the information system to which the present invention is applied has a remote terminal 110, a server system 130, and a network 120 which connects the remote terminal 110 and the server system 130. Here, the network 120 may be the Internet, an Intranet, a wire network or a wireless network. Also, an information system to which the present invention is applied can be implemented with an independent remote terminal 110 and a server system 130 which are not connected to each other.

The remote terminal 110 has an input unit 111 for inputting information; an output unit 112 for outputting information; an interface 114 for connecting to the network 120; an information processing unit 113 for processing data input from the input unit 111, data sent through the interface 114 from the network 120, and data to be output to the output unit 112; and a storage unit 115 for storing various types of information.

The output unit 112 performs a function for displaying a plurality of character values which a user refers to when the user wishes to input secret information, and a screen pointer which the user uses to determine a predetermined character value included in secret information the user wishes to input, among the plurality of character values. An example of the output unit 112 is a display device having a screen. This display device is a means for displaying information which the user can recognize visually, and can include various display devices. Specific examples are a cathode ray tube (CRT) display, a liquid crystal display (LCD), and a beam projector; display devices that are usually used with a computer.

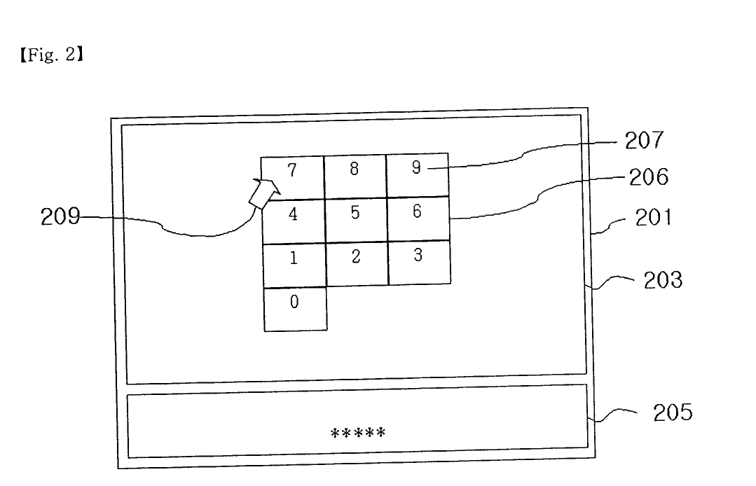

FIG. 2 illustrates an example of the screen of a display device as the output unit 112 on which a plurality of character values and a screen pointer are displayed. Referring to FIG. 2, an input window 201 for a user to input secret information is displayed on the screen of the output unit 112. The input window 201 has a character value display unit 203 and a secret information input confirmation unit 205. In the character value display unit 203, each of the plurality of character values 207 are displayed in a predetermined location so as not to overlap other character values, and the screen pointer 209 which is used to determine a predetermined character value among the plurality of character values 207 is displayed. According to an embodiment of the present invention, each of the plurality of character values 207 is displayed in one of the character value regions, the number of which is the same as the number of character values. Here, the regions in which the respective character values 207 are displayed so as not to overlap other character values are defined as a screen keyboard in the present invention. The secret information input confirmation unit is a window for the user to confirm that any one character value among the plurality of character values displayed on the character value display unit is determined using the screen pointer. At this time, it is preferable that the character value determined by the user using the screen pointer is not displayed as it is on the display screen, but that only an identical predetermined character value is always displayed on the screen so that a third person who watches the display screen cannot figure out secret information being input. For example, in response to user's action of selecting any one character value among the plurality of character values, using the screen pointer, a predetermined character, for example, ‘*’ or ‘#’, is displayed.

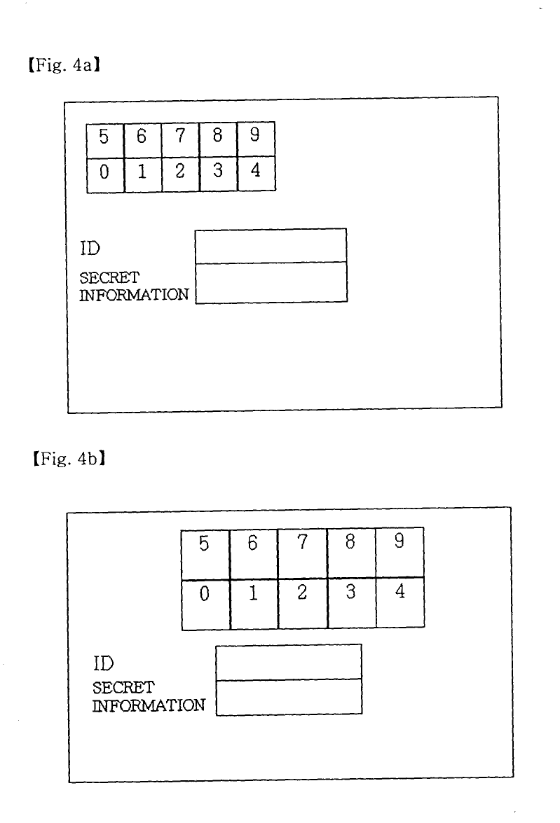

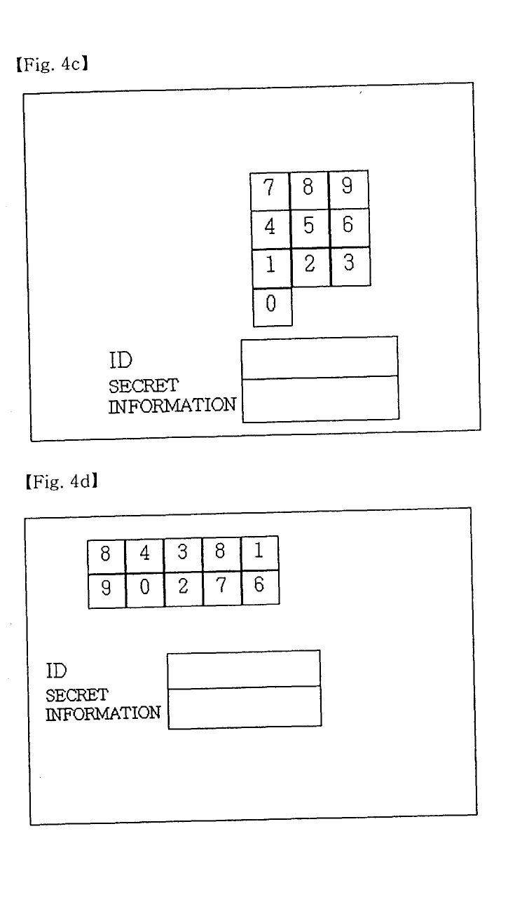

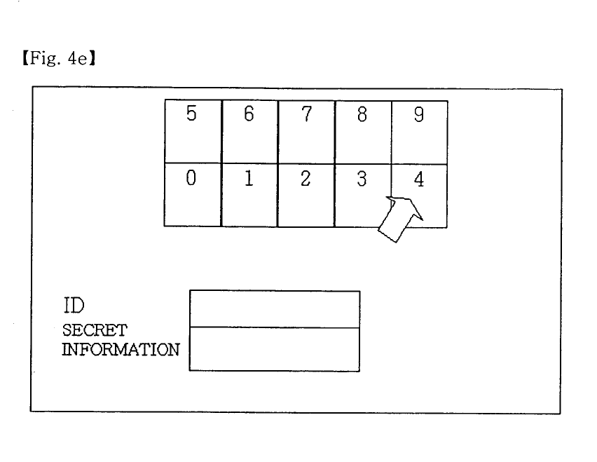

The server system sends character value location information, which is different from previous ones, whenever the user is to input secret information. The output unit 112 arranges the plurality of character values on the display screen, using the location information provided from the server system. Therefore, the arrangement of the plurality of character values displayed on the display screen changes according to the location information provided from the server system, whenever the user is to input a secret character. FIGS. 4A through 4D illustrates four examples, each of which has a different arrangement of the plurality of character values, which are formed of integers from ‘0’ through ‘9’, on the display screen. FIG. 4A is an example having an arrangement in which integers from ‘5’ through ‘9’ are displayed from right to left in the upper left corner of the display screen, and integers from ‘0’ through ‘4’ are displayed from left to right on the line below. FIG. 4B has the same arrangement sequence as the arrangement of FIG. 4A, but shows a case in which the location of each character value on the screen and the size of the character value regions for character values are different from the arrangement of FIG. 4A. FIG. 4C is an example of an arrangement in which integers from ‘7’ through ‘9’ are displayed from left to right in the upper left corner of the display screen, and integers from ‘4’ through ‘6’, integers from ‘1’ through ‘3’, and integer ‘0’ are displayed from left to right on the lines below. FIG. 4D is an example of an arrangement in which integers are arranged in an arbitrary sequence on the same character value regions as FIG. 4A.

The state of the arrangement of the plurality of character values 207 forming the screen keyboard cannot be confirmed unless the state is confirmed with naked eyes, or signals sent to the display device are interpreted. However, it is very difficult to snatch a signal sent to the display device. Also, to snatch the form of the plurality of character values displayed on the screen, a method in which a displayed screen is read in the form of an image to recognize the image must be used. In conclusion, unless a signal sent to the display device is snatched or the display screen itself is read, it is impossible to figure out the state of the arrangement of the plurality of character values.

The input unit 111 performs a function for receiving secret information from a user. The input unit 111 has an event detecting means for detecting various events the user generates. The even detecting means can be implemented in various forms depending on the kinds of events the user generates. For example, if an event the user generates is a key input, the event detecting means is a keyboard for detecting key input. If an event the user generates is an action of moving a part of his body, the event detecting means is mouse, touch pad, or pointing stick for detecting an action of moving a part of his body. If an event the user generates is an action of pushing a button, the event detecting means can be a button on a mouse.

Also, the output unit 112 and input unit 111 can be manufactured in one frame. An example is a touch screen with which the user can select a character value on the screen, using a finger or a separate stick, watching the screen of the output unit 112.

The information processing unit 113 has functions for commanding the output unit 112 to display the plurality of character values on the screen of the display means, using character value location information provided from the server system; processing events generated by the user and detected by the detecting unit; and storing location information of the screen pointer on the screen, when the screen pointer determines a predetermined character value. Also, the information processing unit 113 has functions for performing jobs for a secret information request sent from the server, or interpreting by itself secret information input by the user. The information processing unit 113 can have a secret information input processing unit 116 for processing secret information input by the user and a secret information interpretation unit 117 for interpreting secret information input by the user.

The server system 130 has an input unit 131 for inputting information; an interface 135 for connecting to the network; an information processing unit 134 for determining the location of a character value displayed on the screen of the display means of the remote terminal 110, commanding the location information to be sent to the network through the interface 135, and extracting secret information input by the user through the remote terminal 110, based on location information of character values sent to the network and screen pointer information sent from the remote terminal 110 through the network; a data management unit 133 for managing location information of character values to be displayed on the screen of the display means of the remote terminal 110, and extracted secret information; and an output unit 132 for outputting the processed result.

Also, the secret information processing unit 134 of the server system 130 can be formed of a secret information request unit 136 for requesting the user terminal to input secret information and a secret information interpretation unit 137 for interpreting information sent from the user.

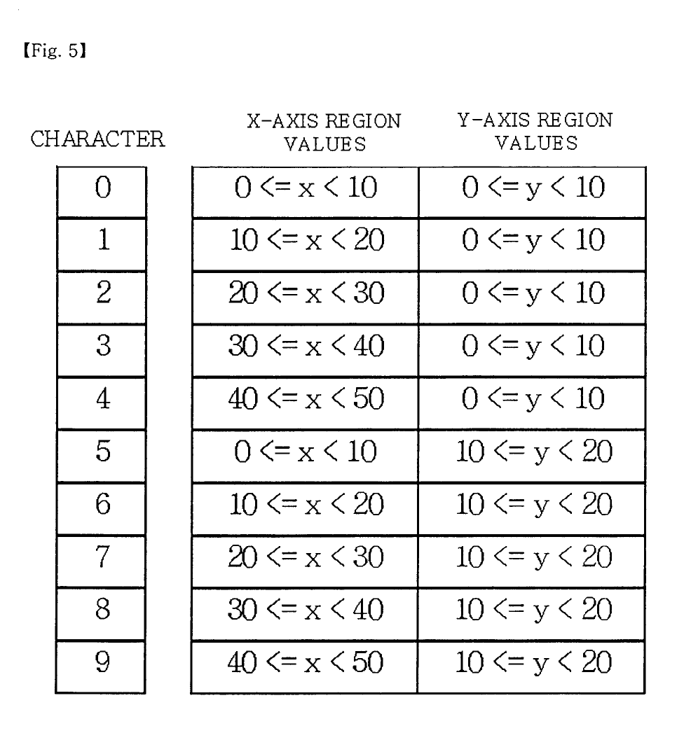

The secret information requesting unit 136 manages location information of the plurality of character values to be displayed on the display means of the remote terminal 110, provides the location information to the remote terminal 110, and receives secret information from the user. That is, the secret information requesting unit requests the user to input secret information when the user tries to access the server system 130, and at this time, provides location information of character values to be displayed on the remote terminal 110 to the remote terminal 110. The character values displayed on the remote terminal based on the location information of character values provided to the remote terminal 110 can be recognized only by the user. FIG. 5 is an example of location information of character values from ‘0’ through ‘9’, particularly having the arrangement of FIG. 4B. The location information of character values as shown in FIG. 5 is converted into a data form which can be transmitted through the network, and then provided to the remote terminal.

The secret information interpretation unit 137 is formed of a module for interpreting secret information, using location information of the plurality of character values provided to the remote terminal 110 and screen pointer information provided from the remote terminal 110.

First Embodiment

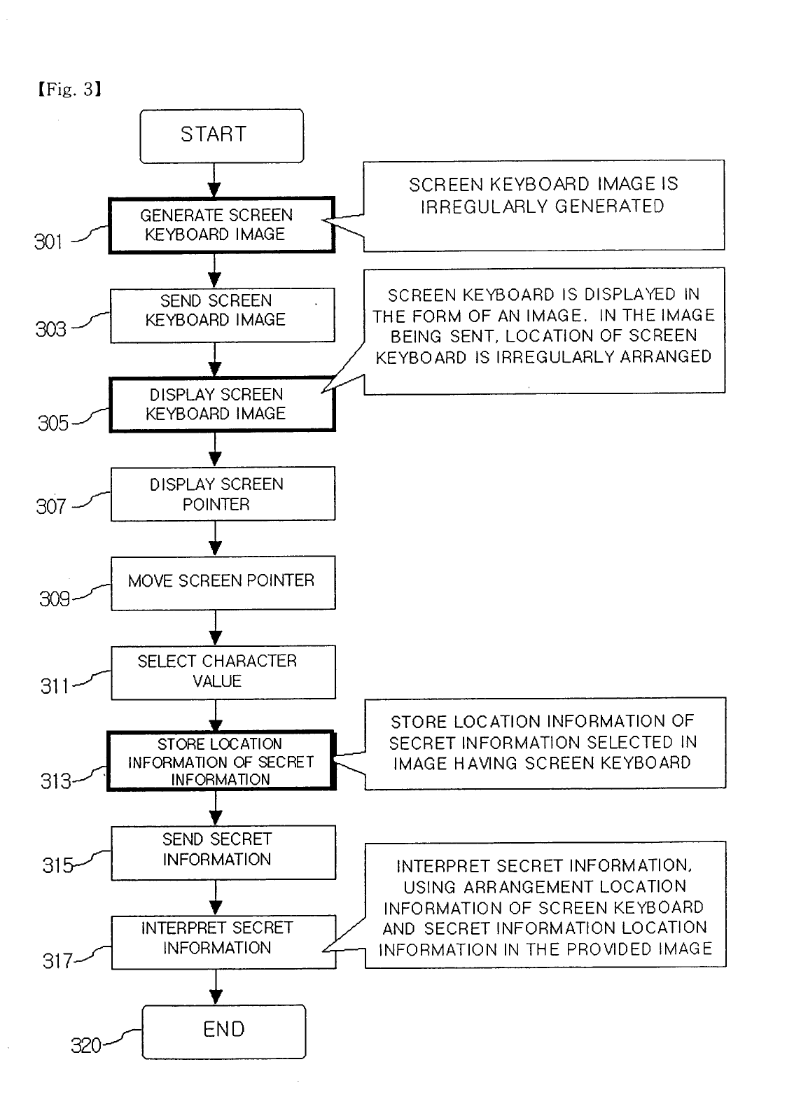

Referring to FIGS. 2 and 3, the process of performing a secret information input method according to an embodiment of the present invention will now be explained. In the present embodiment, an example in which secret information is usually formed of k characters will be explained. In the present invention, each of k characters forming secret information is defined as a secret character.

First, the server system 130 determines information on a location on which each of N characters which can be distinguished from each other is arranged on the display screen of the display means of the remote terminal 110 in step 301. Preferably, the server system 130 records determined location information of a character value in the data management unit 133 of the server system. The number of character values, N, can change depending on the kinds of secret characters forming secret information. In the embodiments of FIGS. 2 and 4A, N is ‘10’ and N character values 207 are integers of ‘0’ through ‘9’. When character values are desired to be displayed on the display screen of the display means of the remote terminal 110 as shown in FIG. 4A, the server system 130 determines location information of character values as shown in FIG. 5.

Then, the server system 130 transmits determined location information to the network 120 through the interface 135. The transmitted location information is received via the interface 114 of the remote terminal through the network 120. According to another embodiment of the present invention, location information transmitted by the server system 130 through the network 120 can be information on an image to be displayed on the display screen of the remote terminal 110. In this image information, location information of characters is included.

The remote terminal 110 displays N character values on the display screen of the display means of the output unit 112 according to the received location information in step 305. The N character values are displayed in the form of character, number, symbol, or figure on each location according to the received location information. If a signal sent from the server system 130 is an image to be displayed on the display screen, the remote terminal 110 displays the image on the display screen, based on the received image information. By doing so, the operation for displaying character values is completed.

According to an embodiment of the present invention, a process for setting N character regions 206 on the screen is performed before displaying character values on the screen. Then, character values are displayed on the already set character regions 206. At this time, each of N character values is displayed on each of N character regions 206 so as not to overlap other character values. By doing so, N character values can be distinguished from each other according to the character regions 206 on which the character values are displayed. According to another embodiment of the present invention, Without setting character regions 206 on the screen, each of N character values can be displayed on appropriate locations so as not to overlap other character values. In this case, N character values can be distinguished from each other according to the location of each character value on the screen.

Then, the remote terminal 110 displays the screen pointer 209 on a predetermined location on the display screen of the display means of the output unit 112 in step 307. The screen pointer 209 moves on the display screen of the display means, being interlocked to user's generation of an event through the event detecting means of the input unit 111. Referring to FIG. 2, an arrow-shaped screen pointer 209 is displayed on a predetermined location on the screen on which N character values 207 are displayed.

The user moves the screen pointer on the display screen by generating a first event through the event detecting means of the input unit 111 in step 309. If the event detecting unit detects the first event generated by the user, the remote terminal moves the screen pointer on the display screen, being interlocked to the event. Examples of the first event generated by the user to move the screen pointer on the screen can include an action of pushing a predetermined key on the keyboard, moving the mouse, or pushing a button on the mouse. In an embodiment of the present invention, user's action of pushing a predetermined key, for example, an upward arrow key or downward arrow key, on the keyboard can be the first event. Or, user's action of moving the mouse itself can be the first event.

After the screen pointer determines a character value that is the same as the secret character the user wishes to input, the user selects the character value as a secret character in step 311. This selecting process is performed in response to user's action of generating a second event. Examples of this second event include an action of pushing a predetermined key on the keyboard, an action of moving the mouse, and an action of pushing a button on the mouse. According to an embodiment of the present invention, user's action of pushing a predetermined key, for example, the enter key, on the keyboard, can be the second event. Or, user's action of pushing a button of the mouse can be the second event.

The detecting means detects the second event input by the user, and responding to this, the remote terminal 110 stores information on the screen pointer at the time when the second event is generated, to a storage medium in step 313, or transmits the information to the network 120 through the interface 114 in step 315. Information on the screen pointer to be recorded in the storage medium includes information on the location of the screen pointer on the display screen at the time when the second event is generated, or information on the history of changes of the screen pointer on the display screen. Also, in the embodiment in which N character value regions 209 are displayed on the display screen and N character values are displayed inside the N character value regions 209 so as not to overlap other character values, information on the location of the character region on which the screen pointer is located at the time when the second event is generated can be information on the screen pointer. Though information on the screen pointer recorded in the storage medium can be read by a third party, the third party cannot snatch secret information input by the user unless the third party knows the arrangement of character values displayed on the display screen. FIG. 4E illustrates a state in which the screen pointer determines character value ‘4’ among the plurality of character values shown in FIG. 4B. If the screen pointer determines character value ‘4’ as shown in FIG. 4E, information on the screen pointer can be, for example, X coordinate value=45, Y coordinate value=4.

Then, the server system 130 interprets secret character input by the user, using information on the screen pointer sent from the remote terminal 110 and location information of character values determined in the step 301 for determining location information of character values, in step 317. When the server system 130 has recorded location information of the determined character values in the data management unit 133 of the server system 130, the recorded location information of the character values can be used.

If the location information of the character values determined by the server system 130 and sent to the remote terminal 110 is as shown in FIG. 5, and information on the screen pointer sent from the remote terminal 110 is, for example, X coordinate value=45, Y coordinate value=4, the server system 130 determines the character value to which the information on the screen pointer belongs, referring to FIG. 5, and by doing so, it can be found that the secret character input by the user is ‘4’.

Modified Embodiment

Referring to FIG. 2, a modified embodiment of the present invention will now be explained.

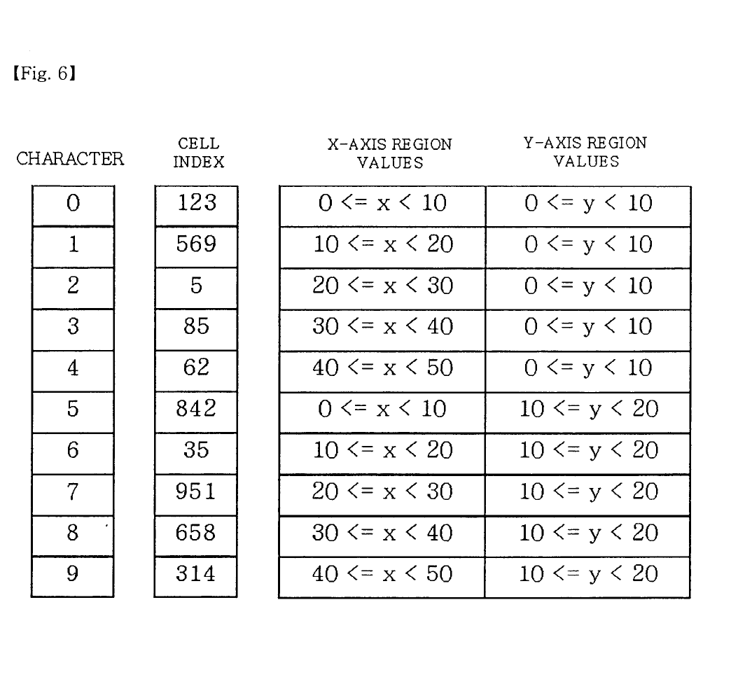

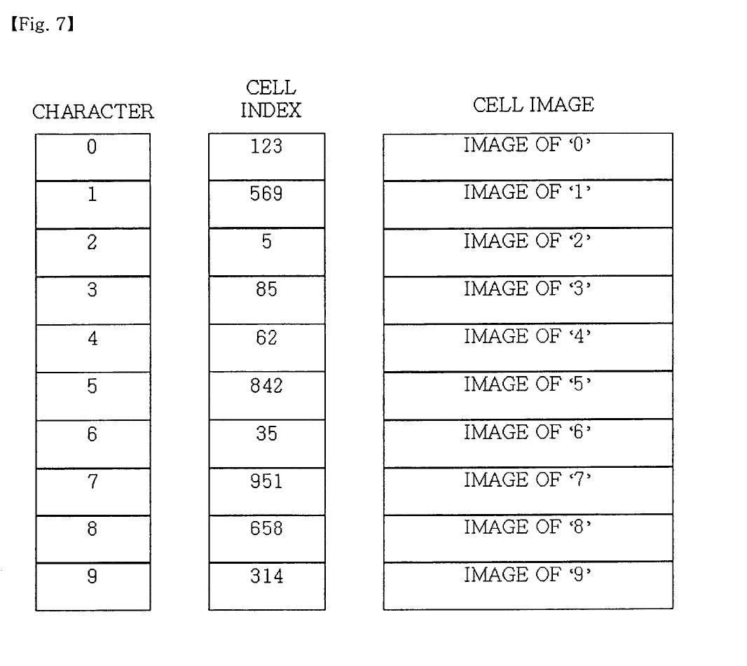

According to the second embodiment of the present invention, the server system 130 determines N reference values for referring to character regions 206, in which N character values that can be distinguished from each other are arranged respectively, in addition to location information of character values, in the step 301 of the first embodiment, in which the server system 130 determines information of a location on which each of N character values that can be distinguished from each other is arranged on the display screen of the display means of the remote terminal 110. FIG. 6 is an example in which, regarding character values of integers ‘0’ through ‘9’, a reference value for referring to each of the character regions in which respective character values are arranged is determined together with location information of each character value. Preferably, as for N character values, reference values having N arbitrary values that are different to each other are determined. Referring to FIG. 6, the reference value of a character value, for example, ‘4’, is ‘62’.

According to the second embodiment, the server system sends reference values for N character values together with location information of N character values to the remote terminal in step 303. The remote terminal 110 displays N character values on the display screen of the display means of the output unit 112 according to the received location information, and at the same time, displays reference values for N character values on the display screen of the display means of the output unit 112 in step 305. N reference values distinguish N character values.

Then, if the user selects a secret character, using the screen pointer, with generating the first and second events, the remote terminal 110 transmits the reference value of the character value which is determined by the screen pointer at the time when the second event is generated, to the network 120 in the steps 313 or 315 for storing information on the screen pointer at the time when the second event is generated, in the storage medium, or for transmitting the information to the network 120 through the interface 114.

Then, the server system 130 interprets the secret character input by the user, using the determined location information of the character values, in the step 301 for determining location information of reference values and character values sent from the remote terminal 110, in step 317. The other steps are the same as those of the first embodiment and therefore detailed explanation will be omitted.

According to a third embodiment of the present invention, the server system 130 determines N reference values for referring to each of N character values that can be distinguished from each other, instead of location information of character values, in the step 301 of the first embodiment, in which the server system 130 determines information of a location on which each of N character values that can be distinguished from each other is arranged on the display screen of the display means of the remote terminal 110. FIG. 7 is an example in which, regarding character values of integers ‘0’ through ‘9’, a reference value which refers to a character value is determined for each of the character values. Preferably, as for N character values, reference values having N arbitrary values that are different to each other are determined. Referring to FIG. 7, the reference value of a character value, for example, ‘4’, is ‘62’.

According to the third embodiment, the server system sends reference values for N character values, instead of location information of N character values, to the remote terminal in step 303. Unlike the first and second embodiments in which location information of N character values are received and according to the received information, character values are displayed, the remote terminal 110 determines on its own the locations of N character values on the display screen. Also, after receiving reference values for N character values, the remote terminal 110 displays N reference values on the display screen so that each character value can be recognized in step 305. N reference values distinguish N character values.

Then, if the user selects a secret character, using the screen pointer, with generating the first and second events, the remote terminal 110 transmits the reference value of the character value which is determined by the screen pointer at the time when the second event is generated, to the network 120 in the steps 313 or 315 for storing information on the screen pointer at the time when the second event is generated, in the storage medium, or for transmitting the information to the network 120 through the interface 114.

Then, the server system 130 interprets the secret character input by the user, using the determined location information of the character values, in the step 301 for determining location information of reference values and character values sent from the remote terminal 110, in step 317. The other steps are the same as those of the first embodiment and therefore detailed explanation will be omitted.

The present invention is not restricted to the above-described embodiments, and many variations are possible within the spirit and scope of the present invention. Therefore, the scope of the present invention is not determined by the description but by the accompanying claims.

The present invention as described above displays a plurality of character values on the screen of a remote terminal in the way a server system has determined. If a user selects a predetermined character value, using the screen pointer, the remote terminal sends location information on the screen pointer at the time when the user selects the character value, to the server so that the server can interpret the secret character input by the user. By doing so, even if all data the user inputs are leaked to a third person, the third person cannot figure out secret information the user inputs, and thus leakage of information is prevented.

That is, if the third person tries to interpret data input in the remote terminal by the user, the third person cannot figure out the content of the secret information and thus even when the third snatches all the process of inputting by user, it is impossible to figure out true secret information. Therefore, information leakage through the conventional information snatching method in which all the process of inputting secret information is snatched can be prevented. For example, though user's input content of an input device, such as a keyboard or mouse, or the recorded content in a storage device is leaked after illegal software is infiltrated in the user's computer, the real leakage of secret information cannot happen.

Also, since it is impossible to distinguish real secret information from information sent through a network such as the Internet from the remote terminal,

the leakage of information by hacking on transmission routes cannot happen. Accordingly, investment necessity for applying encryption solutions such as PKE decreases and thus expenses for a system can be reduced, which is another economical effect of the present invention.

Also, since whenever a secret information is to input, locations on which character values are displayed on the display of the remote terminal change based on location information irregularly determined every time by the server, no regular pattern is generated in the display form of character values, and therefore even if fixed numbers such as secret number, credit card number are repeatedly input, it is difficult to trace the numbers.

What is claimed is:

1. A secret information input method for inputting secret information, using a remote terminal having a detector for detecting an event and a display, to a host computer which is connected to the remote terminal through a communication network, the method comprising:
the host computer determining the location of character values in which information on the location in which each of two or more character values that can be distinguished from each other is arranged on the screen of the display is determined;
sending information on the determined locations to the remote terminal;
the remote terminal receiving the location information and displaying the two or more character values that can be distinguished from each other on the display according to the received information;
displaying a screen pointer on the screen of the display;
moving the screen pointer on the screen of the display in response to a first event detected by the detector;
transmitting information on the screen pointer to the host computer in response to a second event detected by the detector; and
the host computer receiving information on the screen pointer transmitted by the remote terminal and recording the information.

2. The method of claim 1, wherein the determining the location of character values further comprises determining two or more reference values for distinguishing the two or more character values, and the transmitting the location information to the remote terminal further comprises transmitting the determined two or more reference values,
wherein the displaying the character values on the display further comprises displaying the two or more reference values on the display so that the two or more reference values can distinguish each of the displayed two or more character values, and
wherein in the transmitting information on the screen pointer to the host computer, a reference value for a character value determined by the screen pointer among the two or more character values is transmitted to the host computer in response to the second event.

3. The method of claim 1, wherein in the transmitting information on the screen pointer to the host computer, information on the location on which the screen pointer is located on the screen of the display is transmitted.

4. The method of claim 1, wherein the host computer further performs interpreting a character value indicated by the screen pointer at the time when the second event is generated, using location information the two or more character values determined in the determining the location of character values and information on the screen pointer transmitted by the remote terminal.

5. The method of claim 1, wherein the detector includes a first input key and a second input key, the first event is an action of receiving a key input from the first input key, and the second event is an action of receiving a key input from the second input key.

6. The method of claim 1, wherein the detector includes a displacement sensor for sensing changes in displacement of a predetermined object and an input key,
wherein the first event is an action by which a change in the displacement of the substance is sensed by the displacement sensor, and the second event is an action of receiving a key input from the input key.

7. A secret information input method for receiving secret information from a remote terminal having a detector for detecting an event and a display and being connected to a host computer through a communication network, the method comprising:
determining the location of character values in which information on the location in which each of two or more character values that can be distinguished from each other is arranged on the screen of the display is determined;
sending information on the determined locations to the remote terminal; and
the remote terminal receiving the location information and displaying the two or more character values that can be distinguished from each other on the display according to the received information; displaying a screen pointer on the screen of the display; moving the screen pointer on the screen of the display in response to a first event detected by the detector; transmitting information on the screen pointer to the host computer in response to a second event detected by the detector; and in response to this, the host computer receiving information on the screen pointer transmitted by the remote terminal and recording the information.

8. The method of claim 7, wherein the detector includes a first input key and a second input key, the first event is an action of receiving a key input from the first input key, and the second event is an action of receiving a key input from the second input key.

9. The method of claim 7, wherein the detector includes a displacement sensor for sensing changes in displacement of a predetermined object and an input key,
and wherein the first event is an action by which a change in the displacement of the substance is sensed by the displacement sensor, and the second event is an action of receiving a key input from the input key.

10. A secret information input method for inputting secret information, using a remote terminal having a detector for detecting an event and a display, to a host computer which is connected to the remote terminal through a communication network, the method comprising:
receiving information on the location in which two or more character values that can be distinguished from each other are arranged, from the host computer, and displaying the two or more character values that can be distinguished from each other, on the display according to the received information;
displaying a screen pointer on the screen of the display;
moving the screen pointer on the screen of the display in response to a first event detected by the detector; and
transmitting information on the screen pointer to the host computer in response to a second event detected by the detector.

11. The method of claim 10, wherein in the transmitting information on the screen pointer to the host computer, information on the location on which the screen pointer is located on the screen of the display is transmitted.

12. The method of claim 10, wherein in the transmitting information on the screen pointer to the host computer, a reference value for a character value determined by the screen pointer among the plurality of character values is transmitted.

13. The method of claim 10, wherein the detector includes a first input key and a second input key, the first event is an action of receiving a key input from the first input key, and the second event is an action of receiving a key input from the second input key.

14. The method of claim 10, wherein the detector includes a displacement sensor for sensing changes in displacement of a predetermined substance and an input key,
and wherein the first event is an action by which a change in the displacement of the substance is sensed by the displacement sensor, and the second event is an action of receiving a key input from the input key.

15. A secret information input method for inputting secret information, using a remote terminal having a detector for detecting an event and a display, to a host computer which is connected to the remote terminal through a communication network, the method comprising:
the host computer determining two or more reference values for distinguishing each of two or more character values that can be distinguished from each other;
transmitting information on the determined reference values to the remote terminal;
the remote terminal determining the location of character values in which information on the location in which each of two or more character values that can be distinguished from each other is arranged on the screen of the display is determined;
displaying the two or more character values that can be distinguished from each other according to the determined information on the location of character values;
displaying a screen pointer on the screen of the display;
displaying the two or more reference values on the display so that each of the two or more reference values can distinguish each of the displayed two or more character values;
moving the screen pointer on the screen of the display in response to a first event detected by the detector;
transmitting a reference value for a character value determined by the screen pointer among the two or more character values in response to a second event detected by the detector; and
the host computer receiving the reference value information transmitted by the remote terminal and recording the information.

16. The method of claim 15, wherein the detector includes a first input key and a second input key, the first event is an action of receiving a key input from the first input key, and the second event is an action of receiving a key input from the second input key.

17. The method of claim 15, wherein the detector includes a displacement sensor for sensing changes in displacement of a predetermined object and an input key,
and wherein the first event is an action by which a change in the displacement of the object is sensed by the displacement sensor, and the second event is an action of receiving a key input from the input key.

18. The method of claim 15, wherein the host computer further performs interpreting the character value indicated by the screen pointer at the time when the second event is generated, using reference value information determined in the determining reference values, and reference value information transmitted by the remote terminal.

19. A secret information input method for receiving secret information from a remote terminal which detects an event and has a display and being connected to a host computer through a communication network, the method comprising:
determining the location of character values in which information on the location in which each of two or more character values that can be distinguished from each other is arranged on the screen of the display means is determined;
sending information on the determined locations to the remote terminal; and
the remote terminal receiving the location information and displaying the two or more character values that can be distinguished from each other on the display means according to the received information;
displaying a screen pointer on the screen of the display means;
moving the screen pointer on the screen of the display means in response to a first event detected by the detecting means;
transmitting information on the screen pointer to the host computer in response to a second event detected by the detecting means; and
in response to this, the host computer receiving information on the screen pointer transmitted by the remote terminal and recording the information.

20. A secret information input system for inputting secret information, using a remote terminal having a detector for detecting an event and a display, to a host computer which is connected to the remote terminal through a communication network, wherein the host computer comprises:
a character value location determining portion configured to determine information on the location in which each of two or more character values that can be distinguished from each other is arranged on the screen of the display; and
a transmitter configured to transmit information on the determined locations to the remote terminal; and
wherein the remote terminal comprises:
a receiving and displaying portion configured to receive the location information and display the two or more character values that can be distinguished from each other on the display according to the received information;
a displaying and moving portion configured to display a screen pointer on the screen of the display and move the screen pointer on the screen of the display in response to a first event detected by the detector; and
a transmitter configured to transmit information on the screen pointer to the host computer in response to a second event detected by the detector;
wherein the host computer further comprises a receiver configured to receive information on the screen pointer transmitted by the remote terminal and record the information.

21. The system of claim 20, wherein the character value location determining portion further comprises a determining portion configured to determine two or more reference values for distinguishing the two or more character values, and the transmitter of the host computer transmits the determined two or more reference values together,
wherein the receiving and displaying portion displays the two or more reference values on the display so that each of the two or more reference values can distinguish each of the displayed two or more character values and
wherein the transmitter of the remote terminal transmits a reference value for a character value determined by the screen pointer among the two or more character values, to the host computer in response to the second event.

22. A secret information input system for inputting secret information, comprising a remote terminal having a detector for detecting an event and a host computer which is connected to the remote terminal through a communication network, wherein the host computer comprises:
a determining portion configured to determine two or more reference values for distinguishing each of two or more character values that can be distinguished from each other; and
a transmitter configured to transmit information on the determined reference values to the remote terminal; and
wherein the remote terminal comprises:
a character value location determining portion configured to determine information on the location in which each of two or more character values that can be distinguished from each other is arranged on the screen of the display;
a display device configured to display the two or more character values that can be distinguished from each other according to the determined information on the location of character values, display a screen pointer on the screen of the display, and display the two or more reference values on the display so that each of the two or more reference values can distinguish each of the displayed two or more character values;
a moving portion configured to move the screen pointer on the screen of the display in response to a first event detected by the detector; and
a transmitter configured to transmit a reference value for a character value determined by the screen pointer among the two or more character values in response to a second event detected by the detector;
wherein the host computer comprises a receiving and recording portion configured to receive the reference value information transmitted by the remote terminal and record the information.

23. A secret information input system for inputting secret information, using a remote terminal having a detecting means for detecting an event and a display means, to a host computer which is connected to the remote terminal through a communication network, wherein the host computer comprises:
character value location determining means for determining information on the location in which each of two or more character values that can be distinguished from each other is arranged on the screen of the display means; and
means for transmitting information on the determined locations to the remote terminal;
wherein the remote terminal comprises:
means for receiving the location information and displaying the two or more character values that can be distinguished from each other on the display means according to the received information;
means for displaying a screen pointer on the screen of the display means and moving the screen pointer on the screen of the display means in response to a first event detected by the detecting means; and
means for transmitting information on the screen pointer to the host computer in response to a second event detected by the detecting means;
wherein the host computer further comprises means for receiving information on the screen pointer transmitted by the remote terminal and recording the information.

24. A computer readable medium having embodied thereon a computer program for a secret information input method for inputting secret information, using a remote terminal having a detector for detecting an event and a display, to a host computer which is connected to the remote terminal through a communication network,
wherein the secret information input method comprises:
the host computer determining the location of character values in which information on the location in which each of two or more character values that can be distinguished from each other is arranged on the screen of the display is determined;
sending information on the determined locations to the remote terminal;
the remote terminal receiving the location information and displaying the two or more character values that can be distinguished from each other on the display according to the received information;
displaying a screen pointer on the screen of the display;
moving the screen pointer on the screen of the display in response to a first event detected by the detector;
transmitting information on the screen pointer to the host computer in response to a second event detected by the detector; and
the host computer receiving information on the screen pointer transmitted by the remote terminal and recording the information.
